(19) United States
(12) Patent Application Publication
(10) Pub. No.: US 2024/0212063 A1
(43) Pub. Date: Jun. 27, 2024

(54) SYSTEM AND METHOD FOR CONTEXT-AWARE PROFESSIONAL MATCH-MAKING

(71) Applicant: Zealous - FZE, Dubai (AE)

(72) Inventor: Maryam Ahmed HASSANI, Dubai (AE)

(73) Assignee: Zealous - FZE, Dubai (AE)

(21) Appl. No.: 18/392,364

(22) Filed: Dec. 21, 2023

Related U.S. Application Data
(60) Provisional application No. 63/434,660, filed on Dec. 22, 2022.

(51) Int. Cl. G06Q 50/00; G06Q 10/1093

(52) U.S. Cl. CPC G06Q 50/01; G06Q 10/1095

(57) ABSTRACT

The various embodiments herein provide a system and a method for enabling a professional matchmaking between a plurality of individuals and organizations. The embodiments also provide a system and a method to enable context-aware connections based on the needs of both the users being recommended for connections. The method comprises identifying direct connection request, establishing inter-user communication, suggesting user profiles based on geo-location as well as user contexts and requirements, scheduling in-person or virtual meetings, suggesting meeting venues, for in-person meetings, based on the geo-locations of the users, and nurturing connection through follow up meetings. A method is further provided for generating a curated list of candidates based on the contexts of the users' being connected that is beneficial for both the parties in the connection.

### CROSS-REFERENCE TO RELATED APPLICATIONS

The embodiments herein claim the priority of the U.S. Provisional Patent Application filed on Dec. 22, 2022, with the No. 63/434,660 and titled, “SYSTEM AND METHOD FOR CONTEXT-AWARE PROFESSIONAL MATCH-MAKING”, the contents of which are incorporated herein by the way of reference.

### BACKGROUND

### Description of the Related Art

The embodiments herein are particularly related to a system and a method for professional networking. The embodiments herein are more particularly related to a system and a method for enabling a context-aware professional match-making application.

### Description of the Related Art

User interviews and desk research indicate that the members of any professional network, whether tech startup community or conventional business ecosystem, prefer to meet others by asking for referrals from their personal network, search for candidates on platforms like LinkedIn and attend networking events. Members of the professional community schedule meetings with others by: manual back-and-forth in chat or email, sharing a scheduling tool link such as Calendly or SavvyCal or hiring an administrative assistant.

A professional networking application that seamlessly connects individuals or organizations considering user's organizational, professional, and personal requirements needs multiple aspects to be combined together for creating an effective system.

Geolocation-enabled applications can help users go from connecting to meeting as seamlessly as possible, as well as levels the playing field of access and connections to users for building a professional network. However, a system that simply recommends candidates based on a user's connected graph may not reflect the user's actual preferences or requirements.

Hence, there exists a need in our growing tech-world for easy, personal, and meaningful networking applications with hassle-free scheduling and integrations. There also exists a need for a system and a method for algorithmically curating a list of candidates from the entire platform rather than selecting exclusively from the user's own network. There also exists a need for a system and a method that lays lesser emphasis on merely growing a user's existing network and more on understanding the user's set of requirements and context, and accordingly enable them to effectively derive value from their professional network.

The above-mentioned shortcomings, disadvantages and problems are addressed herein, and which will be understood by reading and studying the following specification.

### OBJECT OF THE EMBODIMENTS HEREIN

The primary object of the embodiments herein is to provide a system and a method for professional networking by identifying connections that are beneficial to both the parties being connected.

Another object of the embodiments herein is to provide a system that enables generating a curated list of candidates based on user's personal, professional or organizational context.

Yet another object of the embodiments herein is to provide a system for recommending a curated list of candidates based on the changing networking priorities of a user, including change in residence/work location and an evolved/altered professional requirements.

Yet another object of the embodiments herein is to provide a system that seamlessly transitions the user from establishing connections to scheduling meetings either in-person or virtually and suggesting meeting venues for in-person meeting based on geo-locations of the users.

These and other objects and advantages of the embodiments herein will become readily apparent from the following summary and the detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and a method for enabling a professional matchmaking between a plurality of individuals and (/or) organizations. The embodiments also provide a system and a method to enable context-aware connections based on the needs of both the users being recommended for connections.

According to one embodiment herein, a system provided for context-aware professional matchmaking comprises a plurality of mobile/web-based user applications; application process interface module, calendar integration module, notification service module, back-end module, cloud storage module, cloud database module, cloud compute module, and sensor module.

According to one embodiment herein, a method is provided for enabling professional matchmaking, establishing connection, and enabling interaction between the users. The method comprises identifying direct connection request, establishing inter-user communication, suggesting user profiles based on geo-location as well as user contexts and requirements, scheduling in-person or virtual meetings, suggesting meeting venues, for in-person meetings, based on the geo-locations of the users, and nurturing connection through follow up meetings.

According to one embodiment herein, a method is provided for generating a model for enabling professional matchmaking based on the user's requirement. The method comprises user data collection, data cleaning, exploratory data analysis, feature engineering, similarity measurements, developing a modeling algorithm, analyzing model performance and model deployment.

According to one embodiment herein, a method is provided for generating a curated list of candidates based on the contexts of the users' being connected that is beneficial for both the parties in the connection. The method comprises selecting a set of candidates from the entire platform based on algorithmic models, creating a ranked list of candidates, Heuristics based re-ranking of the candidates considering the contexts of both the parties being connected, and delivering the curated list of candidate recommendation to the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a system for context-aware professional matchmaking, according to one embodiment herein.

FIG. 2 illustrates a method for enabling professional matchmaking, establishing connection and enabling interaction between the users, according to one embodiment herein.

FIG. 3 illustrates a method for generating a model for enabling professional matchmaking based on the user's requirement, according to one embodiment herein.

FIG. 4 illustrates a method for generating a curated list of candidates based on the contexts of the users' being connected, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system and a method for enabling a professional matchmaking between a plurality of individuals and (/or) organizations. The embodiments also provide a system and a method to enable context-aware connections based on the needs of both the users being recommended for connections. The embodiments herein also provide a system and method for enabling an integrated lifecycle management of how people connect, meet, stay connected and grow their networks, through automated referrals and Artificial Intelligence enabled recommendations and scheduling.

According to one embodiment herein, a system provided for context-aware professional matchmaking comprises a plurality of mobile/web-based user applications, application process interface modules, back-end module integrated with a calendar module, notification service module, cloud storage module, cloud database module, a cloud compute module and a sensor module.

According to one embodiment herein, a method is provided for enabling professional matchmaking, establishing connection, and enabling interaction between the users. The method comprises identifying direct connection request, establishing inter-user communication, suggesting user profiles based on geo-location as well as user contexts and requirements, scheduling in-person or virtual meetings, suggesting meeting venues based on the geo-locations of the users and nurturing connection through follow up meetings.

According to one embodiment herein, a method is provided for generating a model for enabling professional matchmaking based on the user's requirement. The method comprises user data collection, data cleaning, exploratory data analysis, feature engineering, similarity measurements, developing a modeling algorithm, analyzing model performance and model deployment.

According to one embodiment herein, a method is provided for generating a curated list of candidates based on the contexts of the users' being connected that is beneficial for both the parties in the connection. The method comprises selecting a set of candidates from the entire platform based on algorithmic models, creating a ranked list of candidates, Heuristics based re-ranking of the candidates considering the requirements of both the parties being connected, and delivering the curated list of candidate recommendation to the user.

According to one embodiment herein, a system is provided for enabling context-aware matchmaking. The system comprises a plurality of user applications, wherein the plurality of user applications are mobile computing and web-based, and wherein, the plurality of application facilitates interactions and connections between a plurality of users for a professional context; an application process interface module for enabling an interface between a plurality of application processes; a back-end module that is configured to process user data, and wherein, the back-end module further comprises an AI module to generate Artificial Intelligence enabled recommendations and scheduling; a calendar module for scheduling interactions between users and facilitate integration with preset digital calendars; a notification service module to enable notifications to users on a plurality of pre-registered computing and communication devices; a cloud storage module, wherein the cloud storage module is configured to store user data, preferences, and the corresponding matchmaking information; a cloud database module, wherein the cloud database module is configured to be interfaced with the cloud storage module and enable the management of the user data, preferences and corresponding matchmaking information; and a cloud compute module, wherein the cloud compute module is configured to run complex data processing methods for generating the context for matchmaking recommendations, and further configured to enable AI based modelling.

According to one embodiment herein, the back-end module comprises an AI module that is configured to operate on an interface to function application model. The AI module is configured to autonomously generate, enhance, and adapt its functions, interfaces, and digital environment based on present context rather than relying on predefined rules. The AI module further comprises: an interface module configured to enable communications external to the AI module; and, a functions module configured to handle a plurality of internal processes.

According to one embodiment herein, the functions module further comprises a plurality of functions, including: a memory function that is configured to manage information in various forms to support the learning and adaptive capabilities of the AI module; system functions including code function and worker function for handling automation, modification of tasks, execution of sequential tasks, and system operations; analytic functions for interpreting and deriving insights from data; creative functions for ideating, refining content, and boosting creativity, further comprising tools including brainstorm function and generation function; abstract functions, including intuition function and analyst function for suggesting solutions, interpreting and analyzing data, and providing intuitive and analytical assistance; prediction function, for anticipating outcomes based on its analysis and learning; an integration function that facilitates the seamless incorporation of external APIs; a plurality of safety functions that incorporates a plurality of safeguards, including a kill switch; and, sandbox function, wherein the AI module is operated in a sandbox environment with full control for execution and testing.

According to one embodiment herein, the interface module is configured with a plurality of hardware and software interfaces, including: a standalone chat interface that enables direct user engagement through a plurality of user devices; a users chat interface that integrates the AI module into conversations, facilitating one-on-one and group interactions; a contacts interface that allows users to add contacts with contextual notes; a business talk interface that enable real-time conversation analysis, integrating sound and visual cues for AI intervention; a registration interface that enables automatic profile creation by scraping social media data; a hints interface that provides automated system-wide suggestions; a connect and professional networking interface that proactively suggests and set up connections based on contextual relevance; an AR interface that enables the AI assistant to manifest in augmented reality; a plurality of system interfaces, including CLI, CRON, UX Analysis, Developer, OS, Kill Switch, and Installation, that collectively manage system operations, maintenance, user behavior analysis, developer access, and installation processes.

According to one embodiment herein, the AI module is further configured for an adaptive application model wherein the AI assistant enhances its own functions, interfaces, and environment based on the context.

According to one embodiment herein, a method is provided for enabling context-aware matchmaking. The method includes: identifying direct connection requests between a plurality of user accounts, wherein the user accounts represent a plurality of individuals and organizations; establishing inter-user communication based on the identified direct connection requests; suggesting user profiles to the connected users by considering geo-location, user contexts and requirements of the users; scheduling in-person or virtual meetings between the connected users, including suggesting meeting venues for in-person meetings based on the geo-locations of the connected users; automatically enabling continuous communication between the users through recommending suitable locations and time for follow-up meetings; and, identifying any change in the requirements, deriving the context accordingly and providing suggestions to connect with newer user accounts.

According to one embodiment herein, the method of suggesting user profiles includes methods for providing recommendations, further comprising: collecting user data; cleaning noisy data; analyzing the data; performing feature engineering and similarity measurements; developing a modeling algorithm; analyzing model performance; and deploying the model to generate a professional matchmaking model based on user requirements.

According to one embodiment herein, the method of enabling inter-user communication further includes: facilitating communication through a mobile and web-based user application; unlocking a user chat option when the connection between users is successful; and, suggesting meeting venues for in-person meetings involves considering the preferences and requirements of the connected users.

According to one embodiment herein, the method for enabling context-aware matchmaking is enabled through a system comprising a plurality of mobile and web-based user applications, an application process interface module, a calendar integration module, a notification service module, a back-end module, a cloud storage module, a cloud database module, a cloud compute module, and a sensor module.

According to one embodiment herein, a method for enabling professional matchmaking includes: verifying whether a user has a direct connection request from another user; suggesting user profiles based on preset rules including geolocation when no direct request is present; checking whether the user connects with the suggested profiles; scheduling a meeting upon user connection; checking the success of the meeting through user-generated responses; unlocking a user chat option when the meeting is successful; and enabling continuous communication between the users through recommending suitable locations and time for follow-up meetings.

According to one embodiment herein, the modeling method is enabled by the back-end module for matching users based on their professional, organizational, and personal contexts, and wherein, the method for generating a curated list of candidates based on the contexts of the users being connected, includes: selecting a set of candidates using preset rules and models; creating a ranked list of candidates; re-ranking of candidates based on heuristics and considering the requirements of both users being connected; and, delivering the curated list of candidate recommendations to the user.

According to one embodiment herein, the method for enabling context-aware matchmaking further includes: managing information in various forms to support the learning and adaptive capabilities of the AI module; handling automation, modification of tasks, execution of sequential tasks, and system operations; interpreting and deriving insights from data; ideating, refining content, and boosting creativity; suggesting solutions, interpreting and analyzing data, and providing intuitive and analytical assistance; anticipating outcomes based on its analysis and learning; incorporating a plurality of external APIs; incorporating safeguards, including a kill switch; and, operating the AI module in a sandbox environment with full control for execution and testing.

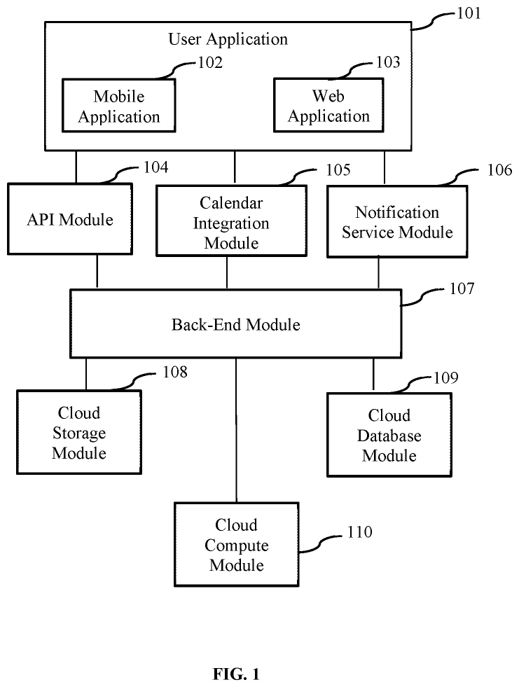

FIG. 1 illustrates a system for context-aware professional matchmaking. The system comprises a plurality of user applications 101, application process interface module 104, calendar integration module 105, notification service module 106, Back-end module 107, cloud storage module 108, cloud database module 109 and a cloud compute module 108. The user application further comprises of a plurality of Mobile applications 102 and web applications 103.

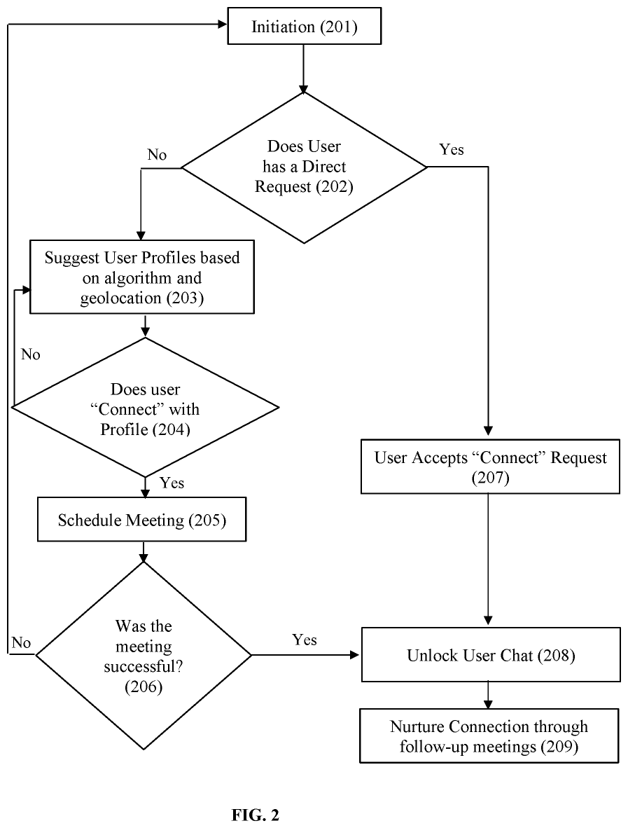

FIG. 2 illustrates a method enabling professional matchmaking, establishing connection, and enabling interaction between the users. The method comprises the following: Initiation (201); Check if user has a direct request (202); When user doesn't have a direct request, suggest user profiles based on algorithm and geolocation (203); check if the user connects with the suggested profiles (204); when the user connects with the profile, schedule a meeting (205); check if the meeting was successful (206); when the meeting was successful, unlock a user chat option (208); and, nurture the connection through follow-up meetings (209). According to one embodiment herein, the user chat options is enabled in the user connects with the profile in as disclosed in 205.

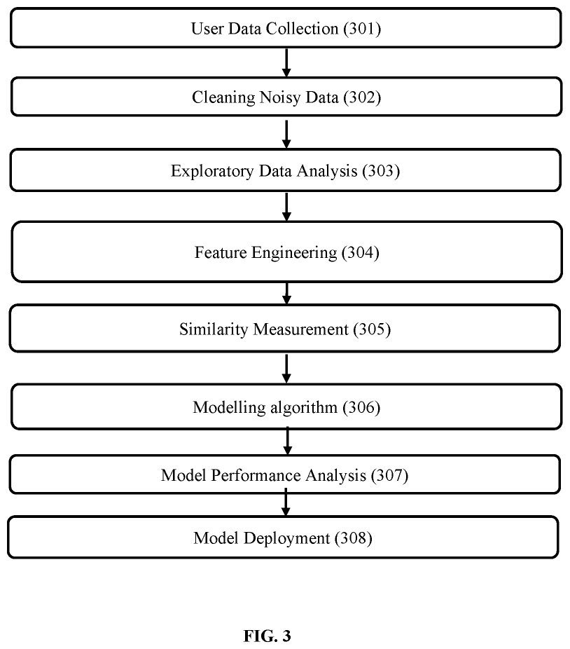

FIG. 3 illustrates a method for generating a model for enabling professional matchmaking based on the user's requirement. The method comprises the following: user data collection (301), Cleaning Noisy Data (302), exploratory data analysis (303), feature engineering (304), similarity measurements (305), developing a modeling algorithm (306), analyzing model performance (307) and model deployment (308).

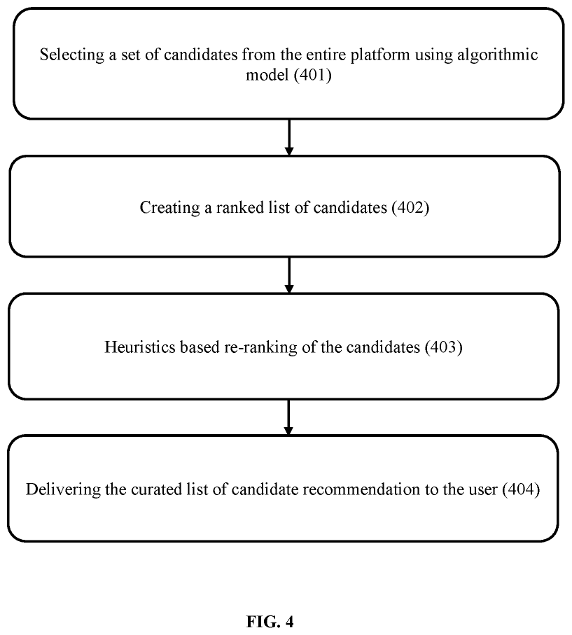

FIG. 4 illustrates a method for generating a curated list of candidates based on the contexts of the users' being connected that is beneficial for both the parties in the connection. The method comprises of the following: selecting a set of candidates from the entire platform using algorithmic model (401), creating a ranked list of candidates (402), Heuristics based re-ranking of the candidates (403), and delivering the curated list of candidate recommendation to the user (404).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is also to be understood that the following claims are intended to cover all of the generic and specific features of the embodiments described herein and all the statements of the scope of the embodiments which as a matter of language might be said to fall there between.

1. A system for enabling context-aware matchmaking, comprising:
a plurality of user applications, wherein the plurality of user applications are mobile computing and web-based, and wherein, the plurality of application facilitates interactions and connections between a plurality of users for a professional context;
an application process interface module for enabling an interface between a plurality of application processes;
a back-end module that is configured to process user data, and wherein, the back-end module further comprises an AI module to generate Artificial Intelligence enabled recommendations and scheduling;
a calendar module for scheduling interactions between users and facilitate integration with preset digital calendars;
a notification service module to enable notifications to users on a plurality of pre-registered computing and communication devices;
a cloud storage module, wherein the cloud storage module is configured to store user data, preferences, and the corresponding matchmaking information;
a cloud database module, wherein the cloud database module is configured to be interfaced with the cloud storage module and enable the management of the user data, preferences and corresponding matchmaking information; and
a cloud compute module, wherein the cloud compute module is configured to run complex data processing methods for generating the context for matchmaking recommendations, and further configured to enable AI based modeling.

2. The system according to claim 1, wherein the back-end module comprises an AI module that is configured to operate on an interface to function application model, and wherein, the AI module is configured to autonomously generate, enhance, and adapt its functions, interfaces, and digital environment based on present context rather than relying on predefined rules, and wherein, the AI module further comprises: an interface module configured to enable communications external to the AI module; and, a functions module configured to handle a plurality of internal processes.

3. The system according to claim 2, wherein the functions module further comprises a plurality of functions, including: a memory function that is configured to manage information in various forms to support the learning and adaptive capabilities of the AI module; system functions including code function and worker function for handling automation, modification of tasks, execution of sequential tasks, and system operations; analytic functions for interpreting and deriving insights from data; creative functions for ideating, refining content, and boosting creativity, further comprising tools including brainstorm function and generation function; abstract functions, including intuition function and analyst function for suggesting solutions, interpreting and analyzing data, and providing intuitive and analytical assistance; prediction function, for anticipating outcomes based on its analysis and learning; an integration function that facilitates the seamless incorporation of external APIs; a plurality of safety functions that incorporates a plurality of safeguards, including a kill switch; and, sandbox function, wherein the AI module is operated in a sandbox environment with full control for execution and testing.

4. The system according to claim 2, wherein the interface module is configured with a plurality of hardware and software interfaces, including: a standalone chat interface that enables direct user engagement through a plurality of user devices; a users chat interface that integrates the AI module into conversations, facilitating one-on-one and group interactions; a contacts interface that allows users to add contacts with contextual notes; a business talk interface that enable real-time conversation analysis, integrating sound and visual cues for AI intervention; a registration interface that enables automatic profile creation by scraping social media data; a hints interface that provides automated system-wide suggestions; a connect and professional networking interface that proactively suggests and set up connections based on contextual relevance; an AR interface that enables the AI assistant to manifest in augmented reality; a plurality of system interfaces, including CLI, CRON, UX Analysis, Developer, OS, Kill Switch, and Installation that collectively manage system operations, maintenance, user behavior analysis, developer access, and installation processes.

5. The system according to claim 2, wherein, the AI module is further configured for an adaptive application model wherein the AI assistant enhances its own functions, interfaces, and environment based on the context.

6. A method for enabling context-aware matchmaking, comprising:
identifying direct connection requests between a plurality of user accounts, wherein the user accounts represent a plurality of individuals and organizations;
establishing inter-user communication based on the identified direct connection requests;
suggesting user profiles to the connected users by considering geo-location, user contexts and requirements of the users;
scheduling in-person or virtual meetings between the connected users, including suggesting meeting venues for in-person meetings based on the geo-locations of the connected users;
automatically enabling continuous communication between the users through recommending suitable locations and time for follow-up meetings; and,
identifying any change in the requirements, deriving the context accordingly and providing suggestions to connect with newer user accounts.

7. The method according to claim 6, wherein the method of suggesting user profiles includes methods for providing recommendations, further comprising: collecting user data; cleaning noisy data; analyzing the data; performing feature engineering and similarity measurements; developing a modeling algorithm; analyzing model performance; and deploying the model to generate a professional matchmaking model based on user requirements.

8. The method according to claim 6, wherein the method of enabling inter-user communication further includes: facilitating communication through a mobile and web-based user application; unlocking a user chat option when the connection between users is successful; and, suggesting meeting venues for in-person meetings involves considering the preferences and requirements of the connected users.

9. The method according to claim 6, wherein the method for enabling context-aware matchmaking is enabled through a system comprising a plurality of mobile and web-based user applications, an application process interface module, a calendar integration module, a notification service module, a back-end module, a cloud storage module, a cloud database module, a cloud compute module, and a sensor module.

10. The method according to claim 6, wherein a method for enabling professional matchmaking includes: verifying whether a user has a direct connection request from another user; suggesting user profiles based on preset rules including geolocation when no direct request is present; checking whether the user connects with the suggested profiles; scheduling a meeting upon user connection; checking the success of the meeting through user-generated responses; unlocking a user chat option when the meeting is successful; and enabling continuous communication between the users through recommending suitable locations and time for follow-up meetings.

11. The method according to claim 6, wherein the modeling method is enabled by the back-end module for matching users based on their professional, organizational, and personal contexts, and wherein, the method for generating a curated list of candidates based on the contexts of the users being connected, includes: selecting a set of candidates using preset rules and models; creating a ranked list of candidates; re-ranking of candidates based on heuristics and considering the requirements of both users being connected; and, delivering the curated list of candidate recommendations to the user.

12. The method according to claim 6, wherein the method for enabling context-aware matchmaking further includes: managing information in various forms to support the learning and adaptive capabilities of the AI module; handling automation, modification of tasks, execution of sequential tasks, and system operations; interpreting and deriving insights from data; ideating, refining content, and boosting creativity; suggesting solutions, interpreting and analyzing data, and providing intuitive and analytical assistance; anticipating outcomes based on its analysis and learning; incorporating a plurality of external APIs; incorporating safeguards, including a kill switch; and, operating the AI module in a sandbox environment with full control for execution and testing.
